(19) United States
(12) Patent Application Publication
(10) Pub. No.: US 2023/0327147 A1
(43) Pub. Date: Oct. 12, 2023

(54) CELL FRAME STRUCTURE AND REDOX FLOW BATTERY USING SAME

(71) Applicants: KORID ENERGY CO.,LTD, Gimpo-si (KR); AUSTRALIA VRFB ESS COMPANY PTY LTD, Perth (AU)

(72) Inventors: Kyong Lock NA, Suwon-si (KR); Byong Hyun SONG, Yongin-si (KR); Geon Woo LEE, Suwon-si (KR); Ho Min LEE, Suwon-si (KR); Soo Whan KIM, Seongnam-si (KR)

(73) Assignees: KORID ENERGY CO.,LTD, Gimpo-si (KR); AUSTRALIA VRFB ESS COMPANY PTY LTD, Perth (AU)

(21) Appl. No.: 18/020,848

(22) PCT Filed: Nov. 6, 2019
(86) PCT No.: PCT/KR2019/014966

§ 371 Date: Feb. 10, 2023

(30) Foreign Application Priority Data
Nov. 5, 2019 (KR) 10-2019-0140488

(51) Int. Cl. H01M 8/0258; H01M 8/0273; H01M 8/18

(52) U.S. Cl. CPC H01M 8/0273; H01M 8/0258; H01M 8/188

(57) ABSTRACT

Provided is a cell frame structure comprising: a rectangular panel-shaped outer frame having a rectangular opening in the center; and a rectangular inner frame, the inner frame interlocking onto the rear surface of the outer frame around the opening thereof to form a flow cell. The flow cell is preferably assembled into a cell frame by the inner frame interlocking onto the rear surface of the outer frame while covering the rim of a bipolar plate, the front-side rim of which is seated around the rear surface opening of the outer frame.

### TECHNICAL FIELD

The present invention relates to a cell frame structure and a redox flow battery, and more particularly, to a cell frame structure and a redox flow battery using the same in which a bipolar plate is disposed on a rear surface of one outer frame, an inner frame interlocks onto the rear surface of the outer frame while covering the bipolar plate to be assembled into one cell frame, and a front surface of the other cell frame interlocks onto a rear surface of any one cell frame to assemble a stack which is sealable without a sealing member or an adhesive member.

### BACKGROUND ART

Recently, as a method for suppressing emission of greenhouse gas as a main cause of global warming, renewable energy such as solar energy or wind energy has been in the spotlight, and many studies for their practical deployment have been conducted. However, such renewable energy is greatly affected by location environments or natural conditions. Furthermore, the renewable energy has a disadvantage that energy cannot be continuously and evenly supplied because the output fluctuation is large.

Therefore, in order to evenly output energy, it is important to develop a storage device capable of storing energy when the output is high and using the stored energy when the output is low, and such representative mass storage devices include lead storage batteries, NaS batteries, and redox flow batteries (RFB).

The lead storage battery is commercially widely used compared to other batteries, but has disadvantages such as maintenance costs due to low efficiency and periodic replacement, disposal problem of industrial waste generated during battery replacement, and the like. Further, the NaS battery has an advantage that the energy efficiency is high, but has a disadvantage in operating at a high temperature of 300° C. or more. On the other hand, the redox flow battery has low maintenance cost, is operable at room temperature, and can independently design a capacity and an output, and thus many researches as a mass storage device have recently been conducted.

Meanwhile, in the case of the redox flow battery, as disclosed in Korean Patent Publication No. 10-2011-116624, Korean Patent Publication No. 10-2013-0082169, Korean Patent Publication No. 10-2018-0000406 and Korean Patent Publication No. 10-2017-0112144, cell frames that are configured by coupling a pair of flow cells onto both sides of a bipolar plate are repeatedly stacked to have advantages of enabling large capacity, being advantageous in size, facilitating capacity expansion, operating at room temperature, and having low initial cost.

However, in a conventional redox flow battery, as the flow cell is configured by coupling a pair of flow cells to both sides of the bipolar plate, a sealing member such as a gasket for keeping a flow channel of the flow cell in an airtight state has a structure to be sealed with an adhesive member.

Therefore, after a plurality of cell frames is repeatedly stacked to form a stack, when rim portions are fixedly coupled to each other through a fastening means such as bolts and nuts, deformation is caused by applying continuous pressure and heat to a portion to which the sealing member such as a gasket is bonded, and as a result, there is a problem that the leakage and short-circuit of an electrolyte are caused.

More specifically, in the case of a general redox flow battery, a plurality of cell frames is repeatedly stacked and end plates are configured at both ends to protect the plurality of cell frames, respectively, and one-side end plate, the plurality of cell frames, and the other-side end plate are coupled into one stack or battery through fastening members such as bolts and nuts to be integrally bound to each other. At this time, the cell frames close to the end plates, which are start ends of positive and negative electrolytes having a relatively high temperature state, are intensively exposed to pressure and heat due to fastening, and as a result, there is a problem that the sealing member covering the flow channel through which the electrolyte flows is deformed.

Therefore, in order to solve the above problems, the thickness of the flow channel of the flow cell or the sealing member needs to be thick, but there are problems in that this design reflection is difficult to process the flow channel and the overall stack is enlarged compared to output power due to the absolute thickness of the flow cell or the cell frames, and an excessive installation space is required.

### DISCLOSURE

### Technical Problem

Therefore, an object of the present invention is to provide a cell frame structure and a redox flow battery using the same, in which a bipolar plate is disposed on a rear surface of one outer frame, an inner frame interlocks onto the rear surface of the outer frame while covering the bipolar plate to be assembled into one cell frame, and a front surface of the other cell frame interlocks onto a rear surface of any one cell frame to assemble a stack which is sealable without a sealing member or an adhesive member.

Other objects of the present invention are not limited to the above-mentioned objects, and other objects not mentioned can be clearly understood by those skilled in the art from the following description.

### Technical Solution

According to the present invention, there is provided a cell frame structure which includes a rectangular panel-shaped outer frame having a rectangular opening in the center; and a rectangular inner frame, wherein the inner frame interlocks onto a rear-side opening portion of the outer frame to configure a flow cell.

Here, the flow cell is preferably assembled into a cell frame by the inner frame interlocking onto the rear surface of the outer frame while covering the rim of a bipolar plate, the front-side rim of which is seated around the rear surface opening of the outer frame.

The outer frame may include a rectangular panel-shaped plate having an opening portion formed in the center; a convex sealing line protruding from the front-side rim of the plate; an inner frame seating surface formed around the front-side opening portion of the plate to seat a rear surface of the inner frame; a positive electrolyte inlet hole formed to penetrate below the front right-side rim of the plate; a positive electrolyte outlet hole formed to penetrate above the front right-side rim of the plate; a negative electrolyte inlet hole formed to penetrate below the front left-side rim of the plate; a negative electrolyte outlet hole formed to penetrate above the front left-side rim of the plate; a convex positive inlet channel which protrudes from the front-side positive electrolyte inlet hole of the plate to the opening portion; a convex positive inlet channel which protrudes from the front-side positive electrolyte inlet hole of the plate to the opening portion; a convex positive inlet channel which protrudes from the front-side positive electrolyte inlet hole of the plate to the opening portion; a convex positive inlet channel which protrudes from the front-side positive electrolyte inlet hole of the plate to the opening portion; a convex flow channel chamber which protrudes around the opening portion along the inner frame seating surface of the plate; a front-side positive inlet gate which is formed in the convex flow channel chamber so that the convex positive inlet channel communicates with the convex flow channel chamber of the plate; a front-side positive outlet gate which is formed in the convex flow channel chamber so that the convex positive outlet channel communicates with the convex flow channel chamber of the plate; a front-side negative inlet gate which is formed in the convex flow channel chamber so that convex negative inlet channel communicates with the convex flow channel chamber of the plate; and a front-side negative outlet gate which is formed in the convex flow channel chamber so that the convex negative outlet channel communicates with the convex flow channel chamber of the plate.

Further, the outer frame may include a concave sealing line protruding from the rear-side rim of the plate; a bipolar seating surface formed around the rear-side opening portion of the plate to seat the front-side rim of the bipolar plate; a convex inner coupling line which protrudes along the rim of the bipolar seating surface to interlock onto a concave outer coupling line of the inner frame while covering the rear-side rim of the bipolar plate; a concave positive inlet channel which protrudes from the positive electrolyte inlet hole formed below the rear left-side rim of the plate to the opening portion; a concave positive outlet channel which protrudes from the positive electrolyte outlet hole formed above the rear left-side rim of the plate to the opening portion; a concave negative inlet channel which protrudes from the negative electrolyte inlet hole formed below the rear right-side rim of the plate to the opening portion; a concave negative outlet channel which protrudes from the negative electrolyte outlet hole formed below the rear right-side rim of the plate to the opening portion; a concave flow channel chamber which protrudes around the opening portion along the bipolar seating surface of the plate; a rear-side positive inlet gate which is formed in the concave flow channel chamber so that the concave positive inlet channel communicates with the concave flow channel chamber of the plate; a rear-side positive outlet gate which is formed in the concave flow channel chamber so that the concave positive outlet channel communicates with the concave flow channel chamber of the plate; a rear-side negative inlet gate which is formed in the concave flow channel chamber so that the concave negative inlet channel communicates with the concave flow channel chamber of the plate; and a rear-side negative outlet gate which is formed in the concave flow channel chamber so that the concave negative outlet channel communicates with the concave flow channel chamber of the plate.

Further, the outer frame may further include negative electrolyte moving holes formed to penetrate between the front-side negative inlet gate and the rear-side negative inlet gate of the plate and between the front-side negative outlet gate and the rear-side negative outlet gate of the plate so that the negative electrolyte moves toward the front surface from the rear surface of the plate.

Further, the inner frame may include a cover having a rectangular frame shape; a contact surface which is formed at an inner periphery of the front-side rim of the cover to be in contact with the rear-side rim of the bipolar plate; a concave outer coupling line which protrudes from the front-side rim of the cover to interlock onto the convex inner coupling line of the outer frame; a positive electrolyte inlet guide and a positive electrolyte outlet guide which are formed in the front-side concave outer coupling line of the cover and disposed at the rear-side positive inlet gate and the rear-side positive outlet gate in an opened structure, respectively; and a negative electrolyte inlet guide and a negative electrolyte outlet guide which are formed in the front-side concave outer coupling line of the cover and disposed at the rear-side negative inlet gate and the rear-side negative outlet gate in a closed structure, respectively.

Further, the inner frame may include an outer frame seating surface which corresponds to the rear surface of the cover and is seated on the inner frame seating surface of the rear-end plate outer frame while interlocking onto the rear surface of the plate; a membrane seating surface which is formed around the outer frame seating surface and seated with a membrane; positive gate closing pieces which correspond to the rear surfaces of the positive electrolyte inlet guide and the positive electrolyte outlet guide and are in contact with the front-side positive inlet gate and the front-side positive outlet gate of the rear-end plate, respectively; and negative gate closing pieces which correspond to the rear surfaces of the negative electrolyte inlet guide and the negative electrolyte outlet guide and are in contact with the front-side negative inlet gate and the front-side negative outlet gate of the rear-end plate, respectively.

Meanwhile, according to the present invention, there is provided a redox flow battery including the cell frame having the configuration; a stack in which a plurality of cell frames is continuously arranged to be dischargeable according to a flow of the electrolyte; a pair of end plates which is configured at both ends of the stack to protect the stack from the outside; and an electrode plate which is electrically connected to positive terminals and negative terminals of the plurality of cell frames of the stack, respectively, while being disposed at the end plate to collect charges of the entire cell frames to be discharged according to a flow of the electrolyte.

### Advantageous Effects

According to the present invention, a bipolar plate is disposed on a rear surface of one outer frame, an inner frame interlocks onto the rear surface of the outer frame while covering the bipolar plate to be assembled into one cell frame, and a front surface of the other cell frame interlocks onto a rear surface of any one cell frame to assemble a stack which is sealable without a sealing member or an adhesive member.

The effects of the present invention are not limited to the aforementioned effects, and other effects, which are not mentioned above, will be apparent to a person having ordinary skill in the art from the description of claims.

### DESCRIPTION OF DRAWINGS

FIGS. 1 and 2 are perspective views illustrating a front surface and a rear surface of a redox flow battery using a cell frame structure according to a preferred embodiment of the present invention, respectively;

FIGS. 3 and 4 are exploded perspective views illustrating a front surface and a rear surface of the redox flow battery according to a preferred embodiment of the present invention, respectively;

FIGS. 5 and 6 are views illustrating a front surface and a rear surface of the cell frame structure of FIGS. 3 and 4, respectively; and

FIGS. 7 and 8 are views illustrating an embodiment in which a positive electrolyte and a negative electrolyte flow in the cell frame structure of FIGS. 3 and 4, respectively.

### BEST MODE OF THE INVENTION

Hereinafter, preferable embodiments of the present invention will be described in detail with reference to the accompanying drawings.

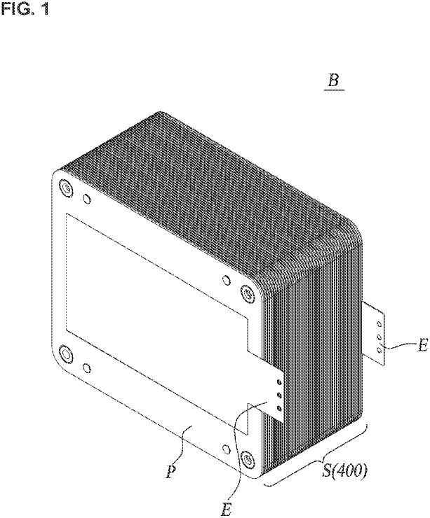

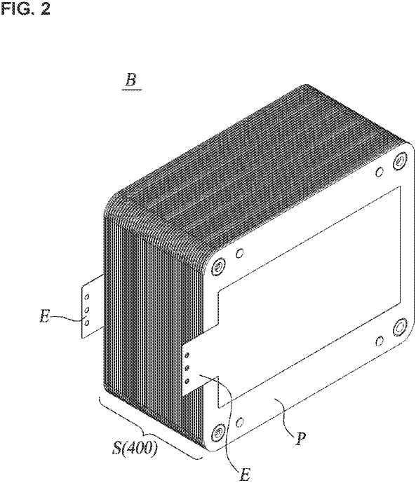

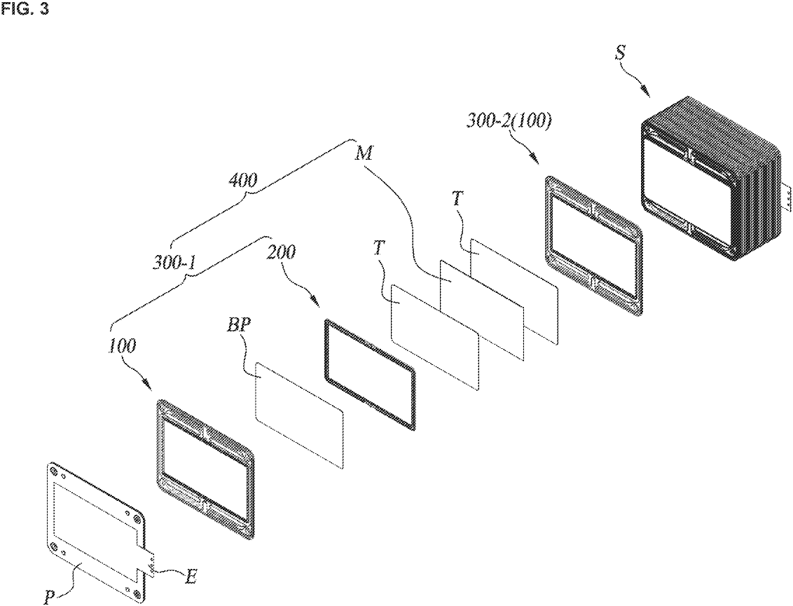

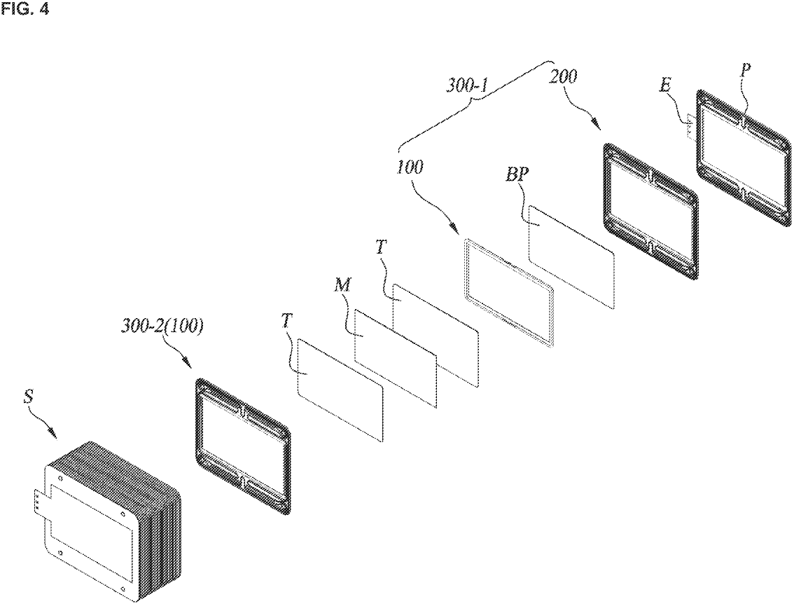

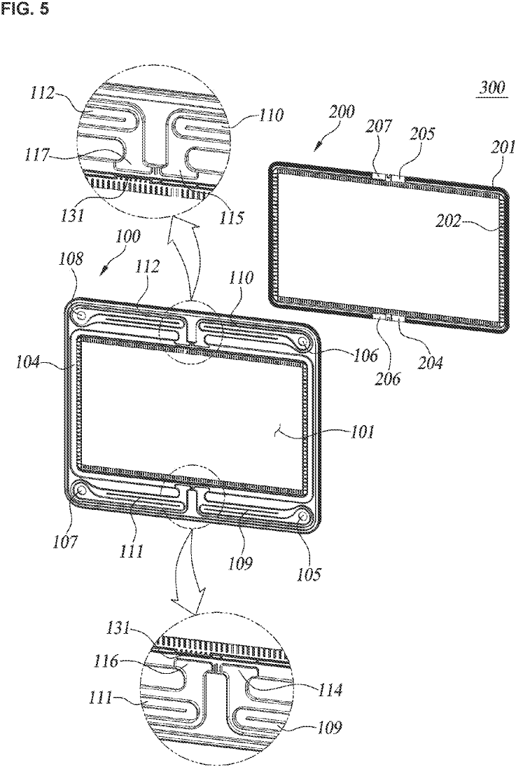

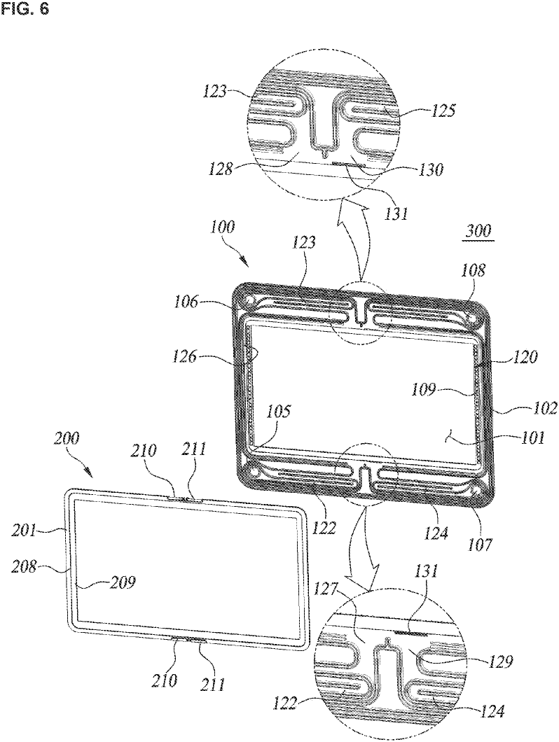

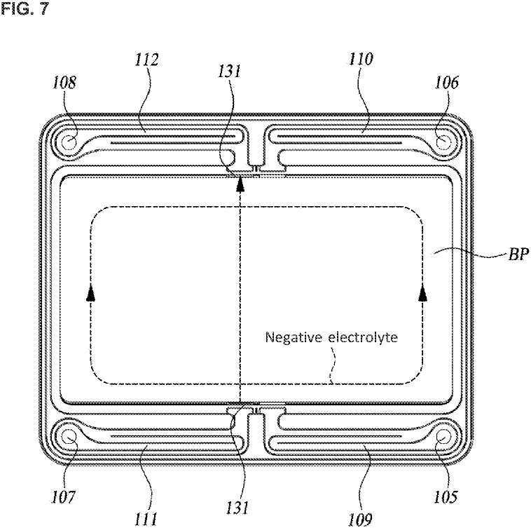

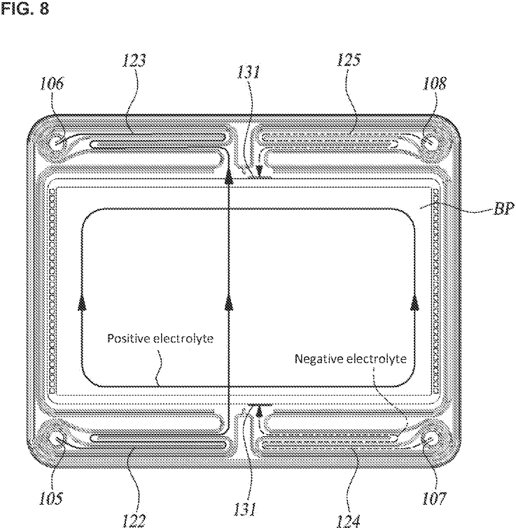

First, as illustrated in FIGS. 1 to 8, in a cell frame structure according to a preferred embodiment of the present invention, largely, a rectangular panel-shaped outer frame 100 having a rectangular opening in the center and a rectangular inner frame 200 to configure a flow cell 300.

Here, in the flow cell 300, while a front-side rim of a bipolar plate BP is seated on an opening portion of a rear surface of the outer frame 100, the inner frame 200 interlocks onto the rear surface of the outer frame 100 while covering a rear-side rim of the bipolar plate BP to be assembled into a cell frame 400.

Further, in the cell frame 400, a plurality of cell frames 400 is assembled into a stack S while a front surface of a rear-end cell frame 400 interlocks onto a rear surface of a front-end cell frame 400.

The outer frame 100 is a frame which interlocks onto the inner frame 200 to configure the cell frame 300 and includes a rectangular panel-shaped plate 102 having an opening portion 101 formed in the center.

Further, the outer frame 100 includes a convex sealing line 103 protruding from the front-side rim of the plate 102, an inner frame seating surface 104 formed around the front-side opening portion 101 of the plate 102 to seat a rear surface of the inner frame 200, a positive electrolyte inlet hole 105 formed to penetrate below the front right-side rim of the plate 102, a positive electrolyte outlet hole 106 formed to penetrate above the front right-side rim of the plate 102, a negative electrolyte inlet hole 107 formed to penetrate below the front left-side rim of the plate 102, a negative electrolyte outlet hole 108 formed to penetrate above the front left-side rim of the plate 102, a convex positive inlet channel 109 which protrudes from the front-side positive electrolyte inlet hole 105 of the plate 102 to the opening portion 101, a convex positive inlet channel 110 which protrudes from the front-side positive electrolyte inlet hole 105 of the plate 102 to the opening portion 101, a convex positive inlet channel 111 which protrudes from the front-side positive electrolyte inlet hole 107 of the plate 102 to the opening portion 102, a convex positive inlet channel 112 which protrudes from the front-side positive electrolyte inlet hole 108 of the plate 102 to the opening portion 101, a convex flow channel chamber 113 which protrudes around the opening portion 101 along the inner frame seating surface 104 of the plate 102, a front-side positive inlet gate 114 which is formed in the convex flow channel chamber 113 so that the convex positive inlet channel 111 communicates with the convex flow channel chamber 113 of the plate 102, a front-side positive outlet gate 115 which is formed in the convex flow channel chamber 113 so that the convex positive outlet channel 112 communicates with the convex flow channel chamber 113 of the plate 102, a front-side negative inlet gate 116 which is formed in the convex flow channel chamber 113 so that convex negative inlet channel 111 communicates with the convex flow channel chamber 113 of the plate 102, and a front-side negative outlet gate 117 which is formed in the convex flow channel chamber 113 so that the convex negative outlet channel 112 communicates with the convex flow channel chamber 113 of the plate 102.

Further, the outer frame 100 includes a concave sealing line 118 protruding from the rear-side rim of the plate 102, a bipolar seating surface 119 formed around the rear-side opening portion 101 of the plate 102 to seat the front-side rim of the bipolar plate BP, a convex inner coupling line 120 which protrudes along the rim of the bipolar seating surface 119 to interlock onto a concave outer coupling line 203 of the inner frame 200 while covering the rear-side rim of the bipolar plate BP, a concave positive inlet channel 122 which protrudes from the positive electrolyte inlet hole 105 formed below the rear left-side rim of the plate 102 to the opening portion 101, a concave positive outlet channel 123 which protrudes from the positive electrolyte outlet hole 106 formed above the rear left-side rim of the plate 102 to the opening portion 101, a concave negative inlet channel 124 which protrudes from the negative electrolyte inlet hole 107 formed below the rear right-side rim of the plate 102 to the opening portion 101, a concave negative outlet channel 125 which protrudes from the negative electrolyte outlet hole 108 formed below the rear right-side rim of the plate 102 to the opening portion 101, a concave flow channel chamber 126 which protrudes around the opening portion 101 along the bipolar seating surface 119 of the plate 102, a rear-side positive inlet gate 127 which is formed in the concave flow channel chamber 126 so that the concave positive inlet channel 122 communicates with the concave flow channel chamber 126 of the plate 102, a rear-side positive outlet gate 128 which is formed in the concave flow channel chamber 126 so that the concave positive outlet channel 123 communicates with the concave flow channel chamber 126 of the plate 102, a rear-side negative inlet gate 129 which is formed in the concave flow channel chamber 126 so that the concave negative inlet channel 124 communicates with the concave flow channel chamber 126 of the plate 102, and a rear-side negative outlet gate 130 which is formed in the concave flow channel chamber 126 so that the concave negative outlet channel 125 communicates with the concave flow channel chamber 126 of the plate 102.

Here, the outer frame 100 further includes negative electrolyte moving holes 131 formed to penetrate between the front-side negative inlet gate 116 and the rear-side negative inlet gate 129 of the plate 102 and between the front-side negative outlet gate 117 and the rear-side negative outlet gate 130 of the plate 102 so that the negative electrolyte moves toward the front surface from the rear surface of the plate 102.

The inner frame 200 interlocks onto the outer frame 100 to configure the flow cell 300, is a frame of which a front surface interlocks onto the rear surface of the outer frame 100 while covering the bipolar plate BP, and includes a cover 201 having a rectangular frame shape.

Further, the inner frame 200 includes a contact surface 202 which is formed at an inner periphery of the front-side rim of the cover 201 to be in contact with the rear-side rim of the bipolar plate BP, a concave outer coupling line 203 which protrudes from the front-side rim of the cover 201 to interlock onto the convex inner coupling line 120 of the outer frame 100, a positive electrolyte inlet guide 204 and a positive electrolyte outlet guide 205 which are formed in the front-side concave outer coupling line 203 of the cover 201 and disposed at the rear-side positive inlet gate 127 and the rear-side positive outlet gate 128 in an opened structure, respectively, to allow the positive electrolyte to be introduced below the rear-side concave flow channel chamber 126 of the plate 102 and discharged above the concave flow channel chamber 126 after coming into contact with the rear surface of the bipolar plate BP, and a negative electrolyte inlet guide 206 and a negative electrolyte outlet guide 207 which are formed in the front-side concave outer coupling line 203 of the cover 201 and disposed at the rear-side negative inlet gate 129 and the rear-side negative outlet gate 130 in a closed structure, respectively, to allow the negative electrolyte to be introduced below the convex flow channel chamber 113 of the front surface of the plate 102 by moving to the front-side negative inlet gate 116 from the rear-side negative inlet gate 129 through the negative electrolyte moving hole 131 without flowing into the rear-side concave flow channel chamber 126 of the plate 102 and discharged above the convex flow channel chamber 113 after coming into contact with the front surface of the bipolar plate BP and then moving to the rear-side negative outlet gate 130 from the front-side negative outlet gate 117.

Further, the inner frame 200 includes an outer frame seating surface 208 which corresponds to the rear surface of the cover 201 and is seated on the inner frame seating surface 104 of the rear-end plate outer frame 100 while interlocking onto the rear surface of the plate 102, a membrane seating surface 209 which is formed around the outer frame seating surface 208 and seated with a membrane M to secure a positive electrolyte reaction chamber and a negative electrolyte reaction chamber between the front-end and rear-end bipolar plates BP, positive gate closing pieces 210 which correspond to the rear surfaces of the positive electrolyte inlet guide 204 and the positive electrolyte outlet guide 205 and are in contact with the front-side positive inlet gate 114 and the front-side positive outlet gate 115 of the rear-end plate 102, respectively, to allow the positive electrolyte of the front surface of the rear-end plate 120 to be introduced below the concave flow channel chamber 126 of the front-end plate 102 without flowing into the convex flow channel chamber 113 of the front-end plate 102 and discharged above the concave flow channel chamber 126 after coming into contact with the rear surface of the bipolar polar BP, and negative gate closing pieces 211 which correspond to the rear surfaces of the negative electrolyte inlet guide 206 and the negative electrolyte outlet guide 207 and are in contact with the front-side negative inlet gate 116 and the front-side negative outlet gate 117 of the rear-end plate 102, respectively, to allow the negative electrolyte of the front surface of the rear-end plate 102 to be introduced below the convex flow channel chamber 113 of the front-end plate 102 through the negative electrolyte moving hole 131 without flowing into the concave flow channel chamber 126 of the front-end plate 102 and discharged above the convex flow channel chamber 113 after coming into contact with the front surface of the bipolar plate BP.

Hereinafter, a process in which the outer frame 100 and the inner frame 200 of the flow cell 300 interlock together with the bipolar plate BP to be assembled into the cell frame 400 will be described as follows.

First, the front-side rim of the bipolar plate BP is seated on the bipolar seating surface 119 of the rear surface of the outer frame 100.

Thereafter, while the front-side contact surface 202 of the inner frame 200 is in contact with the rear-side rim of the bipolar plate BP, the convex inner coupling line 120 of the outer frame 100 is fitted and then pressed to the concave outer coupling line 203 to interlock onto the concave outer coupling line 203. At this time, the positive electrolyte inlet guide 204 and the positive electrolyte outlet guide 205 of the inner frame 200 are disposed at the rear-side positive inlet gate 127 and the rear-side positive outlet gate 128 of the flow cell 300 in an opened structure and the negative electrolyte inlet guide 206 and the negative electrolyte outlet guide 207 are disposed at the rear-side negative inlet gate 129 and the rear-side negative outlet gate 130 of the flow cell 300 in a closed structure.

Meanwhile, a process in which the plurality of cell frames 400 is assembled to the stack S when the rear surface of the cell frame 400 disposed at the front end and the front surface of the cell frame 400 disposed at the rear end interlock onto each other will be described as follows.

First, while the front surface of the outer frame 100 of a rear-end flow cell 300-2 is in contact with the rear surface of the outer frame 100 of a front-end flow cell 300-1, the convex component is fitted and then pressed to the concave component to interlock onto the concave component.

More specifically, the convex sealing line 103 of the rear-end flow cell 300-2 is fitted to the concave sealing line 118 of the front-end flow cell 300-1, and at this time, the rear surface of the inner frame 200 of the front-end flow cell 300-1 is seated on the inner frame seating surface 104 of the rear-end flow cell 300-2 and the electrolyte inlet holes and the electrolyte outlet holes of the front-end flow cell 300-1 and the rear-end flow cell 300-2 communicate with each other.

Further, the convex positive inlet channel 111 and the convex positive outlet channel 112 of the rear-end flow cell 300-2 are fitted to the concave positive inlet channel 122 and the concave positive outlet channel 123 of the front-end flow cell 300-1, and the convex negative inlet channel 111 and the convex negative outlet channel 112 of the rear-end flow cell 300-2 are fitted to the concave negative inlet channel 124 and the concave negative outlet channel 125 of the front-end flow cell 300-1. At this time, the positive gate closing pieces 210 of the front-end flow cell 300-1 are in contact with the front-side positive inlet gate 114 and the front-side positive outlet gate 115 of the rear-end flow cell 300-2 and the negative gate closing pieces 211 of the front-end flow cell 300-1 are in contact with the front-side negative inlet gate 116 and the front-side negative outlet gate 117 of the rear-end flow cell 300-2.

Meanwhile, as described above, when the cell frames 400 are continuously coupled to each other to configure the stack S, the membrane M is disposed on the rear-side membrane seating surface 209 of the front-end flow cell 300, and electrolyte diffusion felts T are configured on the rear surface of the bipolar plate BP and one surface of the membrane M disposed at the front-end flow cell 300 and the front surface of the bipolar plate BP and the rear surface of the membrane M disposed at the rear-end flow cell 300, respectively.

Here, while the bipolar plate BP is mounted on the plurality of flow cells 300 and is separated between the flow cells 300 through the membrane M, when the positive electrolyte and the negative electrolyte are in contact with one surface and the other surface thereof, respectively, positive and negative charges is dischargeable through oxidation and reduction occurring in a reaction chamber between the membrane M and the flow channel chambers. Since the bipolar plate BP is a known configuration, the detailed description will be omitted.

Further, the electrolyte diffusion felts T are configured while coming into contact with the front surface and the rear surface of the bipolar plate BP so that the electrolyte flowing along the bipolar plate BP is evenly in contact with the entire surface of the bipolar plate BP, thereby improving oxidation and reduction efficiency occurring in a space between the bipolar plate BP and the membrane M and simultaneously facilitating collection of charges generated by the oxidation and reduction.

Meanwhile, according to a preferred embodiment of the present invention, the concave component and the convex component of the cell frame 400 are inserted and pressed to interlock onto each other. At this time, it is preferred that a protruding heightof the convex component is about ⅒ to 2/10 larger than that of the concave component, and as a result, when the convex component is inserted and pressed to the concave component, an end portion fitted to a bottom of a groove is curved and deformed to interlock without being separated from the width of the groove.

Here, when the protruding height of the convex component is smaller than the range, a deformed area of the end portion is too small and thus the interlocking is easily released and the sealing is not made. When the protruding height is larger than the range, there is a problem in that the deformed area of the end portion is rather too large and thus the width of the groove of the concave component is increased and the interlocking is not made.

Further, the cell frame 400 of the present invention may have a synthetic resin material such as PP of which a shape is easily deformed during pressing for the interlocking.

Hereinafter, the flow of the positive electrolyte and the negative electrolyte in the stack S assembled by the cell frame structure according to the preferred embodiment of the present invention will be described as follows.

First, a positive circulation pump and a positive electrolyte tank are connected to the positive electrolyte inlet hole 105 below a front right-side rim of the first-end flow cell 300 and the positive electrolyte outlet hole 106 above a rear left-side rim of the last-end flow cell 300 so that the positive electrolyte is circulated. A negative circulation pump and a negative electrolyte tank are connected to the negative electrolyte inlet hole 107 below a front left-side rim of the first-end flow cell 300 and the negative electrolyte outlet hole 108 above a rear right-side rim of the last-end flow cell 300 so that the negative electrolyte is circulated.

Thereafter, in the above state, the positive electrolyte is introduced to the positive electrolyte inlet hole 105 below the front right side of the first-end flow cell 300 from the positive electrolyte tank by the positive circulation pump, and at this time, the positive electrolyte is introduced to spaces between the positive inlet channels communicating with the positive electrolyte inlet holes 105 of the continuous flow cells 300 at the same time.

Thereafter, the positive electrolyte is introduced to a lower portion of the concave flow channel chamber 126 via the rear-side positive inlet gate 127 from the concave positive inlet channel 122 disposed on the rear surface of each front-end flow cell 300-1, discharged above the concave flow channel chamber 126 after coming into contact with the rear surface of the bipolar plate BP, and discharged to the positive electrolyte outlet hole 106 via the rear-side positive outlet gate 128 and the concave positive outlet channel 123 at the same time.

Further, in the above state, the negative electrolyte is introduced to the negative electrolyte inlet hole 107 below the front left side of the first-end flow cell 300 from the negative electrolyte tank by the negative circulation pump, and at this time, the negative electrolyte is introduced to spaces between the negative inlet channels communicating with the negative electrolyte inlet holes 107 of the continuous flow cells 300 at the same time.

Thereafter, the negative electrolyte is introduced to a lower portion of the convex flow channel chamber 113 disposed at the front surface of the flow cell 300 via the rear-side negative inlet gate 129 and the negative electrolyte moving hole 131 from the concave negative inlet channel 124 disposed on the rear surface of each front-end flow cell 300-1, discharged above the convex flow channel chamber 113 after coming into contact with the front surface of the bipolar plate BP, and discharged to the concave negative outlet channel 125 disposed on the rear surface of the flow cell 300 and the negative electrolyte outlet hole 108 via the front-side negative outlet gate 117 and the negative electrolyte moving hole 131 at the same time.

Meanwhile, as illustrated in FIGS. 1 to 8, a redox flow battery B according to the preferred embodiment of the present invention includes a stack S in which the plurality of cell frames 400 having the above configuration is continuously arranged to enable the discharge according to a flow of the electrolyte, a pair of end plates P which is configured at both ends of the stack S to protect the stack S from the outside, an electrode plate E which is electrically connected to positive terminals and negative terminals of the plurality of cell frames 400 of the stack S, respectively, while being disposed at the end plate P to collect charges of the entire cell frames 400 to be discharged according to the flow of the electrolyte, and a fastening reinforcement channel (not illustrated) which is configured on an outer surface of the end plate P to reinforce the fastening between the end plate P and the stack S.

Here, since the configuration of the end plate P, the electrode plate E, and the fastening reinforcement channel (not illustrated) except for the stack S may have a known configuration, the detailed description will be omitted.

The stack S is a battery main body in which the plurality of cell frames 100 is arranged in a stack structure to enable the electrolyte to be dischargeable by oxidation and reduction according to the flow of the electrolyte. The stack S is assembled to the flow cell 300 when the inner frame 200 is fitted and then pressed to the outer frame 100 while coming into contact with the bipolar plate BP to interlock onto each other. While the front surface of the outer frame 100 of the rear-end flow cell 300-2 is in contact with the rear surface of the outer frame 100 of the front-end flow cell 300-1, the convex component is fitted and then pressed to the concave component to interlock onto each other. At this time, the membrane M is disposed on the rear surface of the front-end flow cell 300-1, and electrolyte diffusion felts T are configured on the rear surface of the bipolar plate BP disposed at the front-end flow cell 300-1, one surface of the membrane M, the front surface of the bipolar plate BP disposed at the rear-end flow cell 300-2, and the rear surface of the membrane M, respectively.

Hereinafter, the actions of the redox flow battery B according to the preferred embodiment of the present invention will be described.

First, a positive circulation pump and a positive electrolyte tank are connected to the positive electrolyte inlet hole 105 below the front right-side rim of the first-end flow cell 300 and the positive electrolyte outlet hole 106 above the rear left-side rim of the last-end flow cell 300 so that the positive electrolyte is circulated and a negative circulation pump and a negative electrolyte tank are connected to the negative electrolyte inlet hole 107 below the front left-side rim of the first-end flow cell 300 and the negative electrolyte outlet hole 108 above the rear right-side rim of the last-end flow cell 300 so that the negative electrolyte is circulated.

Thereafter, in the above state, the positive electrolyte is introduced to the positive electrolyte inlet hole 105 below the front right side of the first-end flow cell 300 from the positive electrolyte tank by the positive circulation pump, and at this time, the positive electrolyte is introduced to spaces between the positive inlet channels communicating with the positive electrolyte inlet holes 105 of the continuous flow cells 300 at the same time.

Thereafter, the positive electrolyte is introduced below the concave flow channel chamber 126 via the rear-side positive inlet gate 127 from the concave positive inlet channel 122 disposed on the rear surface of each front-end flow cell 300-1, discharged above the concave flow channel chamber 126 after coming into contact with the rear surface of the bipolar plate BP, and discharged to the positive electrolyte outlet hole 106 via the rear-side positive outlet gate 128 and the concave positive outlet channel 123 atthe same time.

Further, in the above state, the negative electrolyte is introduced to the negative electrolyte inlet hole 107 below the front left side of the first-end flow cell 300 from the negative electrolyte tank by the negative circulation pump, and at this time, the negative electrolyte is introduced to spaces between the negative inlet channels communicating with the negative electrolyte inlet holes 107 of the continuous flow cells 300 at the same time.

Thereafter, the negative electrolyte is introduced below the convex flow channel chamber 113 disposed at the front surface of the flow cell 300 via the rear-side negative inlet gate 129 and the negative electrolyte moving hole 131 from the concave negative inlet channel 124 disposed on the rear surface of each front-end flow cell 300-1, discharged above the convex flow channel chamber 113 after coming into contact with the front surface of the bipolar plate BP, and discharged to the concave negative outlet channel 125 disposed on the rear surface of the flow cell 300 and the negative electrolyte outlet hole 108 via the front-side negative outlet gate 117 and the negative electrolyte moving hole 131 at the same time.

As a result, the positive electrolyte and the negative electrolyte flow in the spaces between the bipolar plate BP and the membrane M, and at this time, positive and negative charges are collected on one surface of each bipolar plate BP while the electrolytes are oxidized and reduced with the membrane M interposed therebetween.

Thereafter, the charges collected in the bipolar plate BP all are collected by the electrode plate E and then supplied to a conversion device such as an inverter to be converted to DC/AC and then supplied to each load.

Accordingly, as described above, the bipolar plate BP is disposed on the rear surface of one outer frame 100 and the inner frame 200 interlocks onto the rear surface of the outer frame 100 while covering the bipolar plate BP to be assembled into one cell frame 400, and the front surface of the other cell frame 400 interlocks onto the rear surface of any one cell frame 400, thereby assembling the stack S which is sealable without a sealing member or an adhesive member.

Further, one cell frame 400 is configured by the outer frame 100 and the inner frame 200 which are coupled to each other to face each other to have a smaller thickness than the related art, thereby configuring a thinner stack S having the same capacity.

In the present invention described above, specific embodiments have been described, but various modifications may be implemented without departing from the scope of the present invention. Therefore, the scope of the present invention is not defined by the described embodiments, but should be defined by claims and equivalents of the claims.

1. A cell frame structure comprising:
a rectangular panel-shaped outer frame (100) having a rectangular opening in the center; and
a rectangular inner frame (200),
wherein the inner frame (200) interlocks onto a rear-side opening portion of the outer frame (200) to configure a flow cell (300).

2. The cell frame structure of claim 1, wherein the flow cell (300) is assembled into a cell frame (400) by the inner frame (200) interlocking onto the rear surface of the outer frame (100) while covering the rear-side rim of a bipolar plate (BP) while the front-side rim of the bipolar plate (BP) is seated around the rear-side opening of the outer frame (100).

3. The cell frame structure of claim 1, wherein the outer frame (100) comprises:
a rectangular panel-shaped plate (102) having an opening portion (101) formed in the center;
a convex sealing line (103) protruding from the front-side rim of the plate (102);
an inner frame seating surface (104) formed around the front-side opening portion (101) of the plate (102) to seat a rear surface of the inner frame (200);
a positive electrolyte inlet hole (105) formed to penetrate below the front right- side rim of the plate (102);
a positive electrolyte outlet hole (106) formed to penetrate above the front right- side rim of the plate (102);
a negative electrolyte inlet hole (107) formed to penetrate below the front left- side rim of the plate (102);
a negative electrolyte outlet hole (108) formed to penetrate above the front left- side rim of the plate (102);
a convex positive inlet channel (109) which protrudes from the front-side positive electrolyte inlet hole (105) of the plate (102) to the opening portion (101);
a convex positive inlet channel (110) which protrudes from the front-side positive electrolyte inlet hole (105) of the plate (102) to the opening portion (101);
a convex positive inlet channel (111) which protrudes from the front-side positive electrolyte inlet hole (107) of the plate (102) to the opening portion (102);
a convex positive inlet channel (112) which protrudes from the front-side positive electrolyte inlet hole (108) of the plate (102) to the opening portion (101);
a convex flow channel chamber (113) which protrudes around the opening portion (101) along the inner frame seating surface (104) of the plate (102);
a front-side positive inlet gate (114) which is formed in the convex flow channel chamber (113) so that the convex positive inlet channel (111) communicates with the convex flow channel chamber (113) of the plate (102);
a front-side positive outlet gate (115) which is formed in the convex flow channel chamber (113) so that the convex positive outlet channel (112) communicates with the convex flow channel chamber (113) of the plate (102);
a front-side negative inlet gate (116) which is formed in the convex flow channel chamber (113) so that convex negative inlet channel (111) communicates with the convex flow channel chamber (113) of the plate (102); and
a front-side negative outlet gate (117) which is formed in the convex flow channel chamber (113) so that the convex negative outlet channel (112) communicates with the convex flow channel chamber (113) of the plate (102).

4. The cell frame structure of claim 3, wherein the outer frame (100) comprises:
a concave sealing line (118) protruding from the rear-side rim of the plate (102);
a bipolar seating surface (119) formed around the rear-side opening portion (101) of the plate (102) to seat the front-side rim of the bipolar plate (BP);
a convex inner coupling line (120) which protrudes along the rim of the bipolar seating surface (119) to interlock onto a concave outer coupling line (203) of the inner frame (200) while covering the rear-side rim of the bipolar plate (BP);
a concave positive inlet channel (122) which protrudes from the positive electrolyte inlet hole (105) formed below the rear left-side rim of the plate (102) to the opening portion (101);
a concave positive outlet channel (123) which protrudes from the positive electrolyte outlet hole (106) formed above the rear left-side rim of the plate (102) to the opening portion (101);
a concave negative inlet channel (124) which protrudes from the negative electrolyte inlet hole (107) formed below the rear right-side rim of the plate (102) to the opening portion (101);
a concave negative outlet channel (125) which protrudes from the negative electrolyte outlet hole (108) formed below the rear right-side rim of the plate (102) to the opening portion (101);
a concave flow channel chamber (126) which protrudes around the opening portion (101) along the bipolar seating surface (119) of the plate (102);
a rear-side positive inlet gate (127) which is formed in the concave flow channel chamber (126) so that the concave positive inlet channel (122) communicates with the concave flow channel chamber (126) of the plate (102);
a rear-side positive outlet gate (128) which is formed in the concave flow channel chamber (126) so that the concave positive outlet channel (123) communicates with the concave flow channel chamber (126) of the plate (102);
a rear-side negative inlet gate (129) which is formed in the concave flow channel chamber (126) so that the concave negative inlet channel (124) communicates with the concave flow channel chamber (126) of the plate (102); and
a rear-side negative outlet gate (130) which is formed in the concave flow channel chamber (126) so that the concave negative outlet channel (125) communicates with the concave flow channel chamber (126) of the plate (102).

5. The cell frame structure of claim 4, wherein the outer frame (100) further comprises negative electrolyte moving holes (131) formed to penetrate between the front- side negative inlet gate (116) and the rear-side negative inlet gate (129) of the plate (102) and between the front-side negative outlet gate (117) and the rear-side negative outlet gate (130) of the plate (102) so that the negative electrolyte moves toward the front surface from the rear surface of the plate (102).

6. The cell frame structure of claim 5, wherein the inner frame (200) comprises:
a cover (201) having a rectangular frame shape;
a contact surface (202) which is formed at an inner periphery of the front-side rim of the cover (201) to be in contact with the rear-side rim of the bipolar plate (BP);
a concave outer coupling line (203) which protrudes from the front-side rim of the cover (201) to interlock onto the convex inner coupling line (120) of the outer frame (100);
a positive electrolyte inlet guide (204) and a positive electrolyte outlet guide (205) which are formed in the front-side concave outer coupling line (203) of the cover (201) and disposed at the rear-side positive inlet gate (127) and the rear-side positive outlet gate (128) in an opened structure, respectively; and
a negative electrolyte inlet guide (206) and a negative electrolyte outlet guide (207) which are formed in the front-side concave outer coupling line (203) of the cover (201) and disposed at the rear-side negative inlet gate (129) and the rear-side negative outlet gate (130) in a closed structure, respectively.

7. The cell frame structure of claim 6, wherein the inner frame (200) comprises:
an outer frame seating surface (208) which corresponds to the rear surface of the cover (201) and is seated on the inner frame seating surface (104) of the rear-end plate outer frame (100) while interlocking onto the rear surface of the plate (102);
a membrane seating surface (209) which is formed around the outer frame seating surface (208) and seated with a membrane (M);
positive gate closing pieces (210) which correspond to the rear surfaces of the positive electrolyte inlet guide (204) and the positive electrolyte outlet guide (205) and are in contact with the front-side positive inlet gate (114) and the front-side positive outlet gate (115) of the rear-end plate (102), respectively; and
negative gate closing pieces (211) which correspond to the rear surfaces of the negative electrolyte inlet guide (206) and the negative electrolyte outlet guide (207) and are in contact with the front-side negative inlet gate (116) and the front-side negative outlet gate (117) of the rear-end plate (102), respectively.

8. A redox flow battery comprising:
a cell frame (400) according to claim 2;
a stack (S) in which a plurality of cell frames (400) is continuously arranged to be dischargeable according to a flow of the electrolyte;
a pair of end plates (P) which is configured at both ends of the stack (S) to protect the stack (S) from the outside; and
an electrode plate (E) which is electrically connected to positive terminals and negative terminals of the plurality of cell frames (400) of the stack (S), respectively, while being disposed at the end plate (P) to collect charges of the entire cell frames (400) to be discharged according to a flow of the electrolyte.

9. The cell frame structure of claim 2, wherein the outer frame (100) comprises:
a rectangular panel-shaped plate (102) having an opening portion (101) formed in the center;
a convex sealing line (103) protruding from the front-side rim of the plate (102);
an inner frame seating surface (104) formed around the front-side opening portion (101) of the plate (102) to seat a rear surface of the inner frame (200);
a positive electrolyte inlet hole (105) formed to penetrate below the front right- side rim of the plate (102);
a positive electrolyte outlet hole (106) formed to penetrate above the front right- side rim of the plate (102);
a negative electrolyte inlet hole (107) formed to penetrate below the front left- side rim of the plate (102);
a negative electrolyte outlet hole (108) formed to penetrate above the front left- side rim of the plate (102);
a convex positive inlet channel (109) which protrudes from the front-side positive electrolyte inlet hole (105) of the plate (102) to the opening portion (101);
a convex positive inlet channel (110) which protrudes from the front-side positive electrolyte inlet hole (105) of the plate (102) to the opening portion (101);
a convex positive inlet channel (111) which protrudes from the front-side positive electrolyte inlet hole (107) of the plate (102) to the opening portion (102);
a convex positive inlet channel (112) which protrudes from the front-side positive electrolyte inlet hole (108) of the plate (102) to the opening portion (101);
a convex flow channel chamber (113) which protrudes around the opening portion (101) along the inner frame seating surface (104) of the plate (102);
a front-side positive inlet gate (114) which is formed in the convex flow channel chamber (113) so that the convex positive inlet channel (111) communicates with the convex flow channel chamber (113) of the plate (102);
a front-side positive outlet gate (115) which is formed in the convex flow channel chamber (113) so that the convex positive outlet channel (112) communicates with the convex flow channel chamber (113) of the plate (102);
a front-side negative inlet gate (116) which is formed in the convex flow channel chamber (113) so that convex negative inlet channel (111) communicates with the convex flow channel chamber (113) of the plate (102); and
a front-side negative outlet gate (117) which is formed in the convex flow channel chamber (113) so that the convex negative outlet channel (112) communicates with the convex flow channel chamber (113) of the plate (102).

10. A redox flow battery comprising:
a cell frame (400) according to claim 3;
a stack (S) in which a plurality of cell frames (400) is continuously arranged to be dischargeable according to a flow of the electrolyte;
a pair of end plates (P) which is configured at both ends of the stack (S) to protect the stack (S) from the outside; and
an electrode plate (E) which is electrically connected to positive terminals and negative terminals of the plurality of cell frames (400) of the stack (S), respectively, while being disposed at the end plate (P) to collect charges of the entire cell frames (400) to be discharged according to a flow of the electrolyte.

11. A redox flow battery comprising:
a cell frame (400) according to claim 4;
a stack (S) in which a plurality of cell frames (400) is continuously arranged to be dischargeable according to a flow of the electrolyte;
a pair of end plates (P) which is configured at both ends of the stack (S) to protect the stack (S) from the outside; and
an electrode plate (E) which is electrically connected to positive terminals and negative terminals of the plurality of cell frames (400) of the stack (S), respectively, while being disposed at the end plate (P) to collect charges of the entire cell frames (400) to be discharged according to a flow of the electrolyte.

12. A redox flow battery comprising:
a cell frame (400) according to claim 5;
a stack (S) in which a plurality of cell frames (400) is continuously arranged to be dischargeable according to a flow of the electrolyte;
a pair of end plates (P) which is configured at both ends of the stack (S) to protect the stack (S) from the outside; and
an electrode plate (E) which is electrically connected to positive terminals and negative terminals of the plurality of cell frames (400) of the stack (S), respectively, while being disposed at the end plate (P) to collect charges of the entire cell frames (400) to be discharged according to a flow of the electrolyte.

13. A redox flow battery comprising:
a cell frame (400) according to claim 6;
a stack (S) in which a plurality of cell frames (400) is continuously arranged to be dischargeable according to a flow of the electrolyte;
a pair of end plates (P) which is configured at both ends of the stack (S) to protect the stack (S) from the outside; and
an electrode plate (E) which is electrically connected to positive terminals and negative terminals of the plurality of cell frames (400) of the stack (S), respectively, while being disposed at the end plate (P) to collect charges of the entire cell frames (400) to be discharged according to a flow of the electrolyte.

14. A redox flow battery comprising:
a cell frame (400) according to claim 7;
a stack (S) in which a plurality of cell frames (400) is continuously arranged to be dischargeable according to a flow of the electrolyte;
a pair of end plates (P) which is configured at both ends of the stack (S) to protect the stack (S) from the outside; and
an electrode plate (E) which is electrically connected to positive terminals and negative terminals of the plurality of cell frames (400) of the stack (S), respectively, while being disposed at the end plate (P) to collect charges of the entire cell frames (400) to be discharged according to a flow of the electrolyte.
